(19) United States
(12) Patent Application Publication
(10) Pub. No.: US 2007/0053010 A1
(43) Pub. Date: Mar. 8, 2007

(54) Scanner

(76) Inventors: Glenn W. Gaarder, Ramona, CA (US); Kevin Bokelman, San Diego, CA (US); David Bradley Short, San Diego, CA (US); Alexandra Pearlman, San Diego, CA (US); Joan Bockman, Oceanside, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/219,436

(22) Filed: Sep. 2, 2005

(51) Int. Cl. H04N 1/04

(52) U.S. Cl. 358/474

(57) ABSTRACT

A scanner is illustrated and described.

### BACKGROUND

Many different types of devices exist that provide for the scanning of an object. Such devices may include printers, copiers, facsimile machines, and scanners. These devices typically have controls that are used to select features and operating options. The provision of such controls, however, may be expensive and may increase the size of the device in some configurations.

### BRIEF DESCRIPTION OF THE DRAWINGS

FIG. 1 is a block diagram of an input device according to an example embodiment.

FIG. 2 is a perspective view of an input device according to an example embodiment.

FIG. 3 is a simplified side view of an input device according to an example embodiment in one example operating state.

FIG. 4 is a simplified side view of an input device according to an example embodiment in another example operating state.

FIG. 5 is a simplified top view of controls according to an example embodiment.

FIG. 6 is a cross section of the controls of FIG. 5 illustrating different operating states, according to an example embodiment.

FIG. 7 is a plan view of an example control panel according to an example embodiment.

FIG. 8 is a cross section of a control according to an example embodiment.

FIG. 9 is an example bottom view of the control of FIG. 8.

FIG. 10 is a cross section of a control according to an example embodiment.

FIGS. 11A-C illustrate three examples of control elements usable in the control of FIG. 10.

FIG. 12 is a view of an indication according to an example embodiment.

FIG. 13 is a view of an indication according to an example embodiment.

FIG. 14 is a cross section of a control according to an example embodiment.

FIG. 15 is an example bottom view of the control of FIG. 14.

FIGS. 16-19 illustrate an example embodiment of a control panel in different configurations.

### DETAILED DESCRIPTION

Referring now to the drawings and more particularly to FIG. 1, there is illustrated an image-processing device 20, such as a computer, scanner, printer, multifunction printer, copier, facsimile machine, or other device that processes an image. Image-processing device 20 may include an image-input device 22 and an image-output device 24. Image input device 22 may include an image source 26 and an indication-input device 28. In one embodiment, indication-input device 28 may receive image information from image source 26 and output image information to image-output device 24. In another embodiment, indication-input device 28 may be coupled to image source 26, with the image source providing image input and output, and with the indication-input device providing indication information to the image source. An indication-input device may accordingly be a stand-alone device, a part of another device, or a combination of devices.

Image information may be of any suitable form, such as image data or signals. Image information also may relate to or include a single image or a series of images, such as a series of documents or images, or a video signal. The image information may be input to an image-processing device by scanning an object, by inputting an image signal, such as a digital or analogue signal, or other suitable means. Indication information may be any communication that it is desired to produce instructions relating to imaging operations on the image information. For instance, when associated with a scanner, the indication information may identify an intended destination or use of associated image information. When associated with a copier or printer, it may relate to the number of hardcopies to be made, or the size or color of images or text to be printed. When associated with a facsimile machine, it may relate to the resolution of the document, the contrast setting, or the telephone number of a recipient machine. Accordingly, image source 26 may be an imaging device, such as a processor of another device, for example, a computer, scanner, printer, multifunction printer, copier, or facsimile machine, or a communication link to another device, such as a wired or wireless network connection, or a processor of a machine that the indication input device forms a part of or is connected to.

Similarly, image output device 24 may be any device to which image information is transferred from image input device 22, or to which indication information is transferred. For example, device 24 may be a printer, multi-function printer, copier, facsimile machine, scanner, computer, processor, or storage device, or a component of such a device with an associated image source.

In one example indication input device 28 may include a processor 30, and a memory 32 coupled to the processor for storing data and operating instructions. Such instructions may be embodied as hardware, firmware, or software. The processor may be any device, such as a computer, microprocessor, or other logic unit adapted to control and receive scanned image information from a scanning device 34. The scanning device may in turn be adapted to scan a scanning zone 36 having an indication region 38. The indication region may be a fixed scan line or a two-dimensional area scanned with a moving or fixed, one-dimensional or two-dimensional scan.

An indication 40 may be disposed for scanning by the scanning device. Indication 40 may be any characteristic perceivable by the scanning device. More particularly, indication 40 may have a plurality of selectable and distinctly optically detectable states viewable in indication region 38. These optically detectable states may be interpretable by processor 30, and may correspond to instructions produced by the processor to effect imaging operations based on the detected state.

Indication 40 may be selected by processor 30 under control of an external device, or by an indication-selection input 42. Input 42 may be coupled directly to the indication, or it may be coupled indirectly to the indication through processor 30.

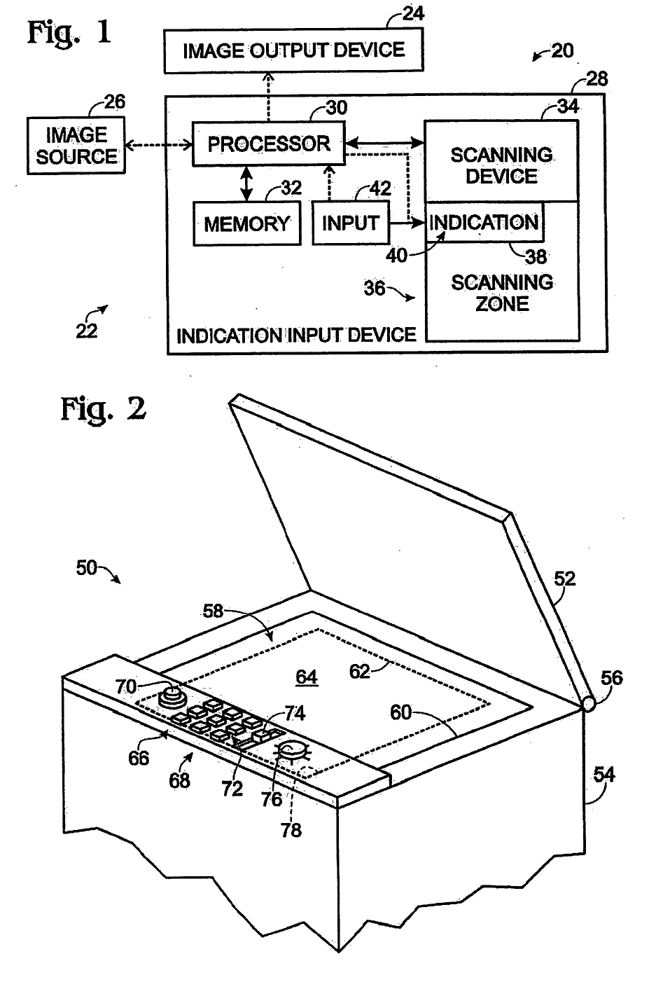

FIG. 2 illustrates an example of an image-processing device 50. Device 50 may include a cover portion or lid 52 attached or otherwise separable from and connected to a housing 54, such as by one or more connection members or hinges 56. Housing 54 may include a viewing surface, pane or window 58 that may be made of glass, plastic, or other material or structure that allows a scanner or scanning device within the housing, to image or scan an object placed on it, in sufficient proximity to it or supported by it.

In one embodiment, window 58 may include an outer border 60 and an inner border 62 defining a scanning zone 64. In some embodiments, image-processing device 50 may not include inner and outer borders, in which case scanning zone 64 and window 58 may be coincident. A control panel 66 mounted on the housing may have a set 68 of a variety of controls, such as a push-button 70, a key-pad 72, a slider 74, and a dial 76. These controls may control one or more indications, not shown in this figure, that are optically detectable for scanning in an indication region 78 of scanning zone 64 covered by control panel 66. The control panel may also be positioned in lid 52, and may be positioned over other sections of scanning zone 64. If the position of the indication zone or zones is coincident with a region where an object is customarily scanned, the scanning of the indication region and an object can be performed sequentially. When the indication region is adjacent an object scanning region, the scanning can be performed concurrently or sequentially.

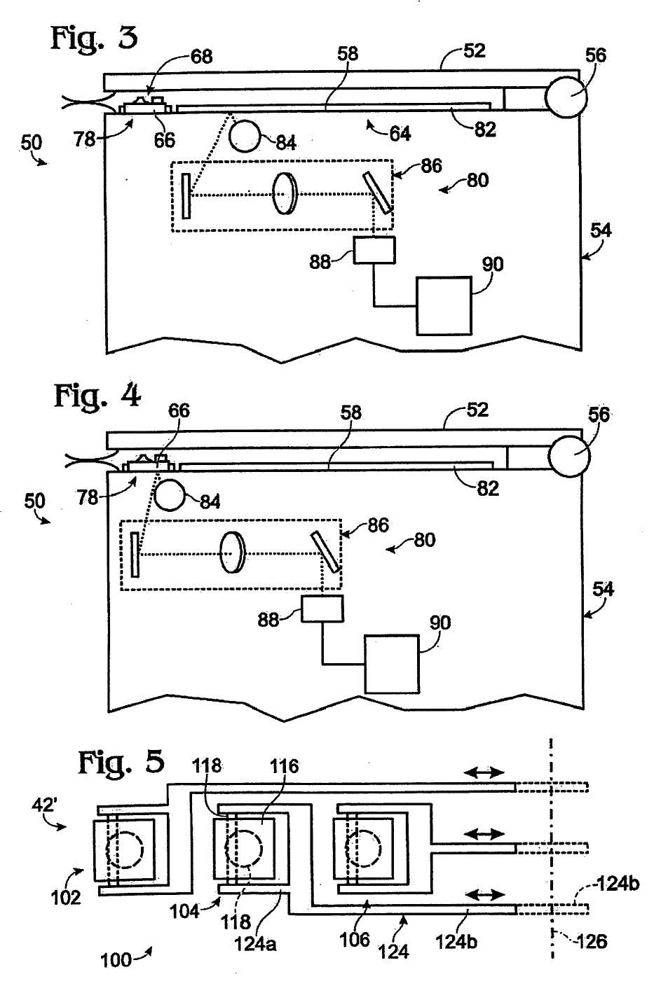

Simplified side views of image-processing device 50 in two operative positions are illustrated in FIGS. 3 and 4. In FIG. 3, a scanning device 80 disposed in housing 54 below window 58 is provided to illuminate and scan an object 82, such as an image on a sheet of paper, that is positioned on or adjacent to a window 58. In one configuration, an illuminating device 84, such as an LED, bulb or other light source, illuminates a face of object 82. Light reflected from the object may be detected by one or more optical devices, referred to generally as optics 86. Optics 86, in turn, may transfer or direct the reflected light from object 80 to a receiver 88. Receiver 88 may be adapted to capture and digitize the image information from the reflected light. For example, the receiver may include a contact imaging sensor or a charge-coupled device that creates a digital image signal representative of the image of the object. A linear or two-dimensional receiver may be used to detect a fixed or moving scan line or two-dimensional scan region. The scanned image signal may then be transferred to a processor 90 for further processing and use. The processor may receive the information in a form that can be directly utilized, or may, if required, perform manipulations, indication identification, character recognition or conversion of a code into a different form.

FIG. 4 illustrates image-processing device 50, with scanning device 80 positioned to scan the lower surface of the control panel along indication region 78. Information input from the set of controls as one or more indications, thereby may be illuminated and imaged, as was the case for an object 82 described with reference to FIG. 3. The resulting indication information may then be fed to receiver 88 and processor 90, as was described for processor 30 with reference to FIG. 1. In particular, the processor may be adapted to produce instructions suited to effect imaging operations based on the state of the scanned indications. In this example, image-processing device 50 includes the associated indication-input device, and processor 30 may be included as part of or integrated into processor 90.

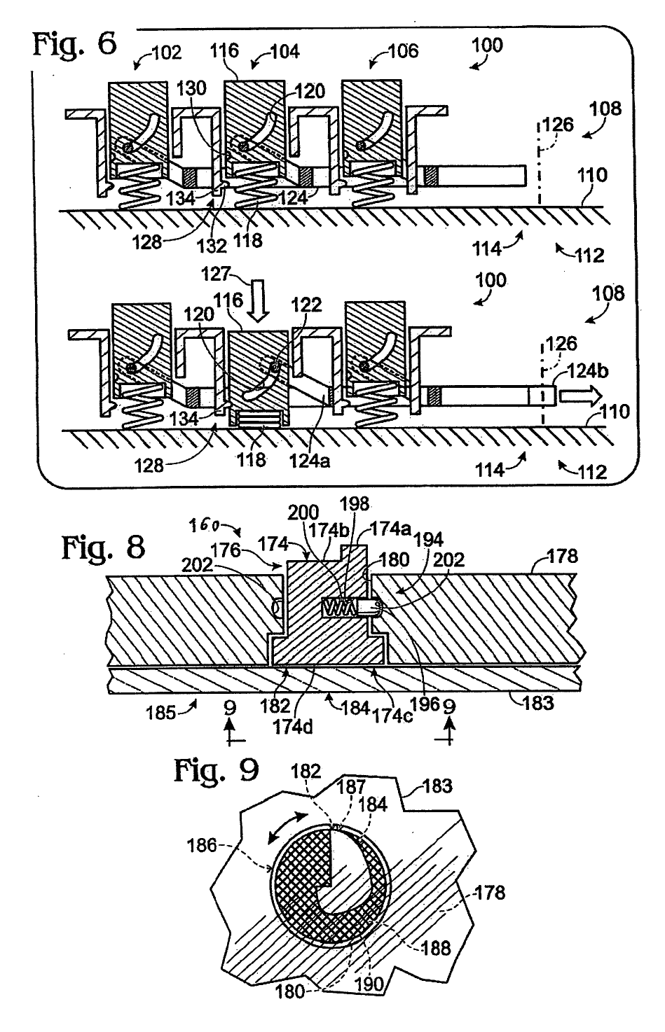

The remaining figures illustrate examples of devices that can be used to produce indications for scanning by a scanning device, although any device providing a selectable indication may be used. FIGS. 5 and 6 illustrate one example of keys adapted to be used in keypad 72. FIG. 5 illustrates a top view of a set 100 of key assemblies 102, 104 and 106 that may function as an input 42′ individually or collectively. Key set 100 can be considered a keypad or a portion of a keypad. The key assemblies can also be used independently. As will be apparent, the structure shown provides two input states. FIG. 6 is a cross-section of the keys as installed in an indication-input device 108, illustrating the function of the keys. Indication-input device 108 includes a window 110 or other transparent or supporting structure providing a scanning zone 112, including an indication region 114.

As shown in the figures, the three keys illustrated are structured and function similarly. The following description is directed to key assembly 104, with the understanding that the same or a similar description applies to the other two key assemblies. Key assembly 104 may include a push button 116, also referred to as an input element. A spring 118 may be seated on window 110 or other housing structure, and may bias the push button upwardly, as shown in FIG. 6. Each push button has a pair of transversely angled slots, such as slot 120 through which a drive rod 122 extends. An indication element 124 may include a U-shaped end 124a that straddles the push button and is attached to opposite ends of drive rod 122. The distal, indication end 124b of the indication element may extend parallel to window 110 and adjacent to a scan line 126 in indication region 114.

As shown in FIG. 6, as a handle of push button 116 is pushed with a downward force 127, a lateral force toward the scan line is exerted onto drive rod 122. This force is transferred to indication element 124, causing the indication element to move in the direction of the scan line, such as to the positions shown in dashed lines in FIG. 5, and the position of indication end 124b shown in FIG. 6. The key assemblies can be designed to return the handle of the push button to the upright position with the indication element retracted when pressure is released from the handle of the push button. As used herein, handle refers to a mechanical user interface without restriction of possible configuration.

As provided for keypad 100, a retention mechanism 128 provides for temporarily securing the indication element in the extended position. This is illustrated simply as the combination of an indent 130 formed in the side of the key and a detent 132 in the side of a frame element 134 of the associated control panel or housing. The positions of the indent and detent may be reversed. Other suitable retention mechanisms may be used, such as a sliding or rotating cam of the type found in a common writing pen. The push button 116 may then be released from the depressed position shown by a further pressure on the push button with a quick release, causing the detent to move past the indent and return to the initial, upright position. This correspondingly moves the indication element to the retracted position shown in the top illustration in FIG. 6 through action of the push button on the drive rod. A further illustration of a retention mechanism is also shown in FIG. 8 described below.

Each key assembly may provide an indication, such as indication relative to the scan line. With this configuration, indication on the scan line is determined by the presence or absence of indication end 124b of the indication element. The condition of the element being absent from or present on the scan line or indication region of the scanning zone is accordingly information that is detected by the processor based on information derived from the image of a scan of the indication. In some embodiments, as described further below, an indication may be determined by the relative position of an indication element along a scan line or in an indication region, the width of an element along a scan line, the orientation of the indication element in the indication region, the actual image, such as an alpha-numeric character or other symbol, presented in the indication region, as well as any other form of indication that provides an optically distinctive image detectable by scanning the indication region and distinguishable from one or more other images.

A keypad can be used to represent numbers, letters or other meanings as appropriate. For instance, if a push button is pushed, it may represent a number, whereas, a push button that is not pushed may represent the absence of the number. Successive scans may thus be used to input a series of numbers, such as a telephone number to be dialed. In some embodiments, the combination of indications for the key assemblies of a keypad may be used to define a binary number. As an example, pressing the first and third push buttons could represent the binary number 000101 in a six-button keypad, corresponding to the decimal number 5.

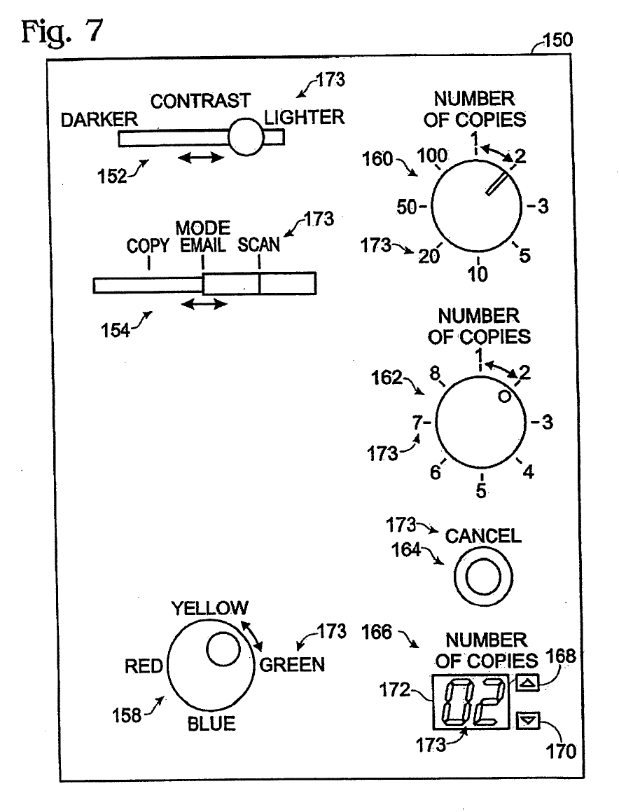

FIG. 7 is an illustration of an example control panel 150 as viewed by a user. Control panel 150 includes a variety of controls, including a continuous linear contrast control 152, an incremental or discrete-stepped process control 154, a continuous two-dimensional color-control dial 158, discrete-stepped rotary copy-control dials 160 and 162, a push-button process control 164, and an electronic copy control 166 with control keys 168 and 170 and digital display 172. Indicia 173 are provided for each control to provide an indication of the control information being indicated by the control configuration. The controls illustrated provide examples of different types of controls. Controls are shown for controlling similar functions. In an actual application, this redundancy may apply to different devices or processes, or may not be used.

FIGS. 8 and 9 show an example embodiment of a structure for a discrete-step rotary dial 160. A similar structure can be used for rotary dial 162. Dial 156 may include a cylindrical control element 174 having a handle 174a extending away from an exposed surface 174b. The portion of the control element including the handle and exposed face may form an input element 176. Control element 174 may be mounted in a base element 178 having an opening 180 generally conforming to the shape of the control element and sized to allow rotation. An enlarged indication end 174c of the control element may retain the control element in the opening, and form an indication element 182. In this example, the base element and control element are supported on or within view of a scan window 183 aligned with an indication region 184 of a scan zone 185.

FIG. 9 shows one example of a face 174d of the control element that can be used to form an indication 186. Indication 186 may be formed by a progressively increasing spiral 187 of a first pattern or color, such as white, surrounded by a field 188 of a second, contrasting pattern or color, such as black. In this example, the field and spiral are contained within a circular edge 190 corresponding to the edge of control-element face 174d. Even with the particular design shown, there are different ways of determining the indication. For instance, the indication may be determined by the orientation of the spiral, by the proportion of the two colors on one side of a scan line, or the proportion of the two colors along the scan line. In the latter instance, each diagonal of the circular pattern, corresponding to the intersection of the pattern with the scan line, may represent an indication. As the control element is rotated by a user applying a force against handle 174a, face 174d rotates, changing indication 186.

Dial 156 is shown with an optional retention mechanism 194. Mechanism 194 may include a detent element 196 slidingly received in a channel 198 formed in the side of the control element. A spring 200 may bias detent element 196 radially outwardly. The detent element may be restricted in outward movement by the walls of opening 180. The walls of opening 180 may include a series of indents 202 distributed around the walls. The detent and indents may be structured to allow continuous rotation of the control element with an applied force greater than a minimum force. The indents may be aligned with selected indicia 173 on or surrounding the upwardly directed face, such as the surface 174b, of the control element, relating the position or operation of the input element to the associated indication. Various indicia 173 for controls are illustrated in FIG. 7.

Other designs for indication faces may be used to provide visually distinct indications. For instance, the indicia on the faces of control dials 156, 158, 160 and 162 shown in FIG. 7 with suitably contrasting colors can be used. A particular design depends on the application the control is to be used for.

The structure of a continuous rotary dial can be the same as that shown for dial 160, without a retention mechanism 194.

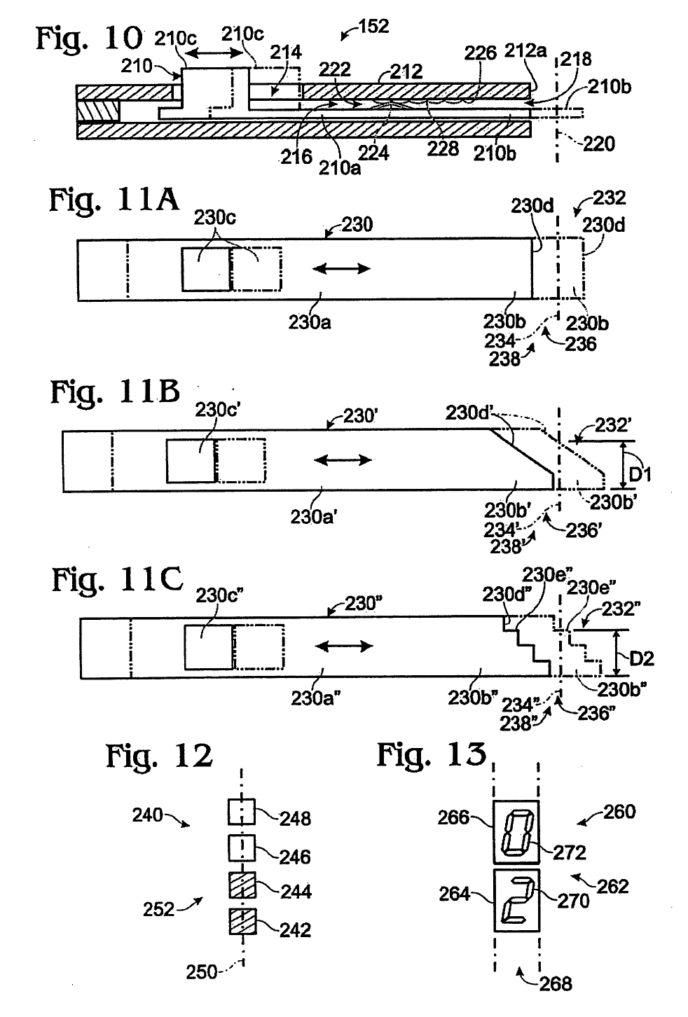

FIGS. 10 and 11A, 11B and 11C illustrate example embodiments of a linear or slider control element, such as control 152. Control 152 may include a slide element 210 mounted in a frame 212 having an upwardly open slot 214, a channel 216 extending between the slot and an opening 218 at an edge 212a of the frame. Slide element 210 may include an elongate body 210a, with an indication end 210b extending beyond opening 218, and a handle 210c projecting through and above the slot.

Slide element 210 is shown in FIG. 10 in solid lines in a retracted position or state in which indication end 210b is spaced from a scan line 220. Handle 210c can be moved along slot 214 to move indication end 210b to an extended position, shown in dash-double-dot lines. In the extended position, the indication end may extend to or through the scan line.

In some embodiments, a detent mechanism 222 may be provided. A detent mechanism may retain the slide element at one or more selected positions along the travel path at or between the retracted and extended positions. Detent mechanism 222 may include a detent element 224 mounted, for example, on the slide element, and an indent element 226 having a plurality of indents 228 aligned for sequential engagement of detent element 224 as the slide element is moved between the positions or states. The indent and detent elements may be made of resilient materials or a combination of rigid and resilient materials to provide resilient urging of one or both of the elements toward the other when the detent is between indent positions.

The slide element may have different configurations as appropriate for a particular application. Three examples are illustrated in FIGS. 11A-11C. A slide element 230 has an elongate body 230a, with a flat or squared-off indication end 230b, and a handle 230c. Slide element 230 may be suitable for a two-state indication 232, with the states determined by the presence or absence of indication end 230b on a scan line 234 of an indication region 236 of a scan zone 238. In this example, the distal edge 230d of the slide element is parallel with the scan line, although this is not required.

FIG. 11B shows a slide element 230′ with an indication end 230b′ having a tapered distal edge 230d′. This slide element may be used, for example, for a control having a continuous range of indication settings, such as contrast control 152. As the distal edge moves between a retracted position, shown in solid lines, and a fully extended position, shown in dash-double-dot lines, the length of the slide element intersecting scan line 234′ may vary. The length of the slide element along the scan line, one example of which is identified as a distance D1, may determine the relative value of a multiple-state indication 232′. Each position or selected positions of edge 230d′ as it moves through the scan line may be considered to be a state of the indication, as well as the input element, handle 230c′. Slide element 230′ when coupled with a detent mechanism, such as mechanism 222, may also function in a discrete-step control.

FIG. 11C illustrates a slide element 230″ particularly adapted for use in a discrete-step control. This slide element is constructed similar to slide element 230′. Rather than having a continuously tapered distal edge, it has a stepped edge 230d″ having one or more steps, such as a step 230e″, that provides a constant length, such as length D2, along a scan line 234″ for a limited length of travel of the slide element moving transverse to the scan line, as shown. Each step, then, corresponds to a discrete value or state of an indication 232″. A configuration of this type may thus be used as a discrete step control, such as an operating mode control 154 with each step corresponding to a mode of processing scan information. Accordingly, steps may designate the use of the scanned image information, such as to produce a copy, to transmit the image information in an email message, or simply as a scanned item to be stored electronically. This type of control can also indicate a color of the scanned image, a number of copies to make of the image, or other information. Other functions may also be controlled with such a slide element. Use may be facilitated when used with a mechanism providing a series of stops corresponding to the positions of the steps of the distal edge of the slider as it passes through the scan line.

The controls described with reference to FIGS. 8-11 have been mechanical devices that provide an indication in an indication region. FIGS. 12 and 13 illustrate indications that may be provided electronically in an indication region. For example, an electronic control element 166 shown in FIG. 7 may be used with corresponding control circuitry or logic, such as may be provided by a processor 30 shown in FIG. 1, to produce the indications shown in FIGS. 12 and 13.

Specifically, FIG. 12 illustrates an electronic indication display 240 including image units 242, 244, 246 and 248. These image units may be separate output units, such as individual liquid-crystal displays (LCDs) or light-emitting diodes (LEDs) that have on and off states having visually contrasting colors. In this example, the output units are aligned along a scan line 250 and form collectively an indication 252. Other ways may be provided to produce an equivalent display, such as a single display device with predefined image regions, or other symbols of states arranged in a two-dimensional display. As has been discussed with regard to mechanical keypads, such a display can be used as a code to represent image-processing information, such as a binary representation of a number of copies to be provided. In this example, with image units 242 and 244 having a contrasting color to image units 246 and 248, the binary number 0011 could be indicated, corresponding to a decimal number 3. Depending on the application, any number of image units, from one to many, can be used.

FIG. 13 illustrates the display of an indication 260 produced by an electronic digital display 262. Display 262 includes image units 264 and 266 aligned in a two-dimensional indication region 268 that may be scanned with a moving scan line. Each image unit displays an alpha-numeric or other character or symbol, such as characters 270 and 272. Again, the image units may be formed as separate image devices or image regions of a single image device. Display 262 may be controlled by a stand-alone character generation circuit or logic unit, or as part of a more comprehensive processor or controller. Either of these options may be represented by a processor 30 depicted in FIG. 1, coupling a control element, such as element 166, with an indication display, such as display 262. Accordingly, the input control element may be physically close to the indication display, such as in a control panel 150 mounted on a housing for a scan device adapted to scan the associated indication region. Further, the input control element may be more distantly located, such as at a site separate from the scan device housing or remote from the indication display, and may be coupled to the display with any suitable information transmission system, such as a processor or communication link, whether connected directly or indirectly through a network, or wired or wireless communication media.

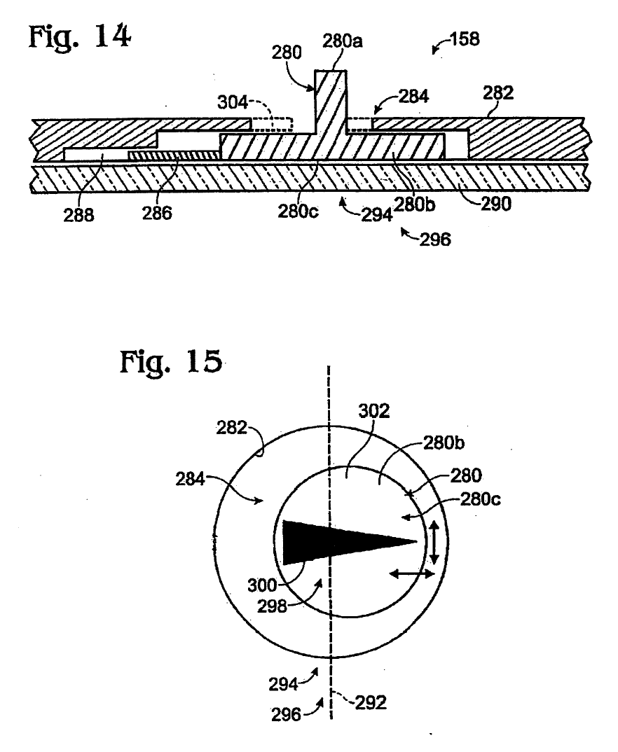

FIGS. 14 and 15 depict an exemplary structure for continuous two-dimensional dial 158. Dial 158 includes a control element 280 mounted in a base element 282 having an opening 284 accommodating two-dimensional movement of the control element within opening 284. Control element 280 includes a control knob 280a extending upwardly from an indication plate 280b.

The base element and control element may be supported on a scan window 290 aligned with a scan line 292 of an indication region 294 of a scan zone 296. FIG. 15 illustrates the bottom view of a sample indication face 280c of dial 158 visible along scan line 292. Face 280c may include an indication 298 formed of an elongate wedge 300 in one color, such as black, on a field 302 of another color, such as white, that provides sufficient contrast for the elongate wedge to be visually distinguished from the field. Other forms, shapes, or devices may be used to provide an indication. In this example, the combination of the width of the wedge in scan line 292 and the position of the wedge along the scan line, may be used to indicate the color selection of the user as defined by a color space represented by the face of the dial as viewed by a user, and as shown in FIG. 7. For example, the position of the control knob 280 adjacent to an outer edge of opening 284 may indicate a maximum intensity of a particular hue. A position closer to the center then may represent a more neutral or whiter color level.

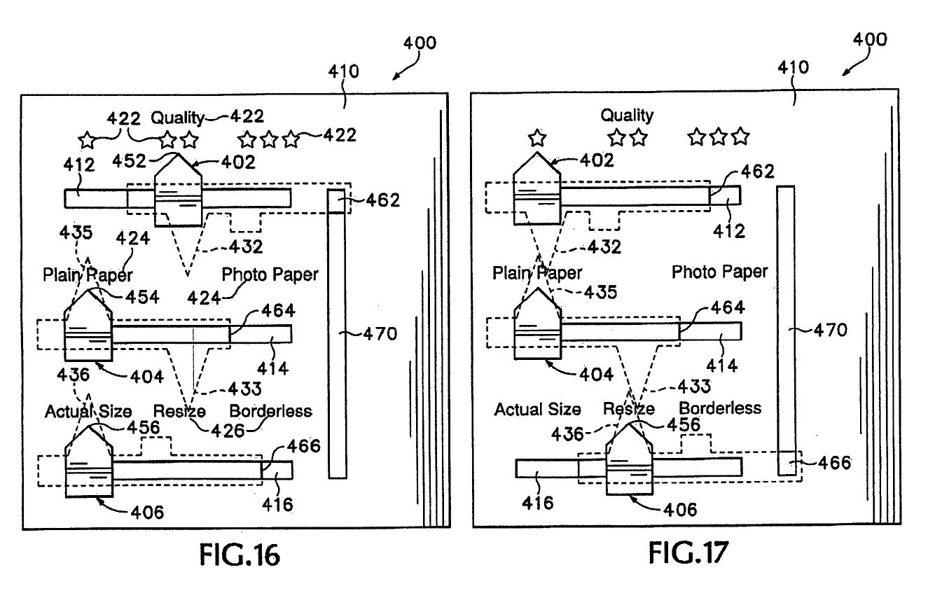

FIGS. 16-19 illustrate an example embodiment of mechanically linked sliders 402, 404, 406 as a part of a control panel 400 of a suitable imaging device. Each slider 402-406 is shown as being slidably disposed in an associated slot 412, 414, 416. Written indicia 422, 424, 426 may be disposed on a surface 410 of the device. The written indicia 422-426 may indicate different device operating parameters of an associated device.

Portions of each slider 402, 404, 406 disposed on a side of the surface 410 opposite the indicia are illustrated in dashed lines. Hence, each of the sliders 402, 404, 406 includes a portion on each side of the surface 410. In particular, the slider 402 includes arm 432. The slider 404 includes arms 433 and 435. The slider 406 includes arm 436. The arms 432-436 are sized and positioned so that they may interfere with each other so as to passively limit movement of one or more of the associated sliders.

Each slider 402, 404, 406 also includes an indicator portion 452, 454, 456 disposed on a same side of the surface 410 as the indicia 422, 424, 426. The indicator portions 452, 454, 456 are connected to the associated arms. Moreover, the indicator portions may be visible to a user such that the user may align the indicator portions 452, 454, 456 with desired locations of the associated indicia 422, 424, 426 to make device parameter selections. These selections may include, for example, quality, paper type, and size. Other suitable selections may also be used.

FIG. 16 illustrates the sliders 402, 404, and 406 in an unengaged configuration where none of the arms are contacting arms of other sliders. In FIG. 16, the indicator portion 452 selects a “two-star” quality, the indicator portion 454 selects plain paper, and the indicator portion 456 selects actual size by being aligned with the associated indicia 422, 424, 426. By scanning along the scan line 470, the imaging device detects these settings by the presence of end 462 within the scan line 470.

FIG. 17 illustrates the sliders 402, 404, and 406 in an example engaged configuration. In this configuration, the arm 432 engages, or contacts, the arm 435, to maintain the indicator portion 435 aligned with the “plain paper” selection. the arm 433 engages the arm 436 to prevent the indicator portion 456 from aligning with the “borderless” selection. Hence, in this configuration, when “one star” quality is selected by the slider 402, the arms 432, 435 limit selection of the slider 404 to “plain paper”. Also, in this configuration the arm 433 limits the selection of the slider 406 to “actual size” and “resize”. Accordingly, in this example, when “one-star” quality is selected by the slider 402, engagement of the arms prevents selection of “photo paper” by the slider 404 and prevents selection of “borderless” by slider 406. By scanning along the scan line 470, the imaging device detects these settings by the presence of end 466 within the scan line 470.

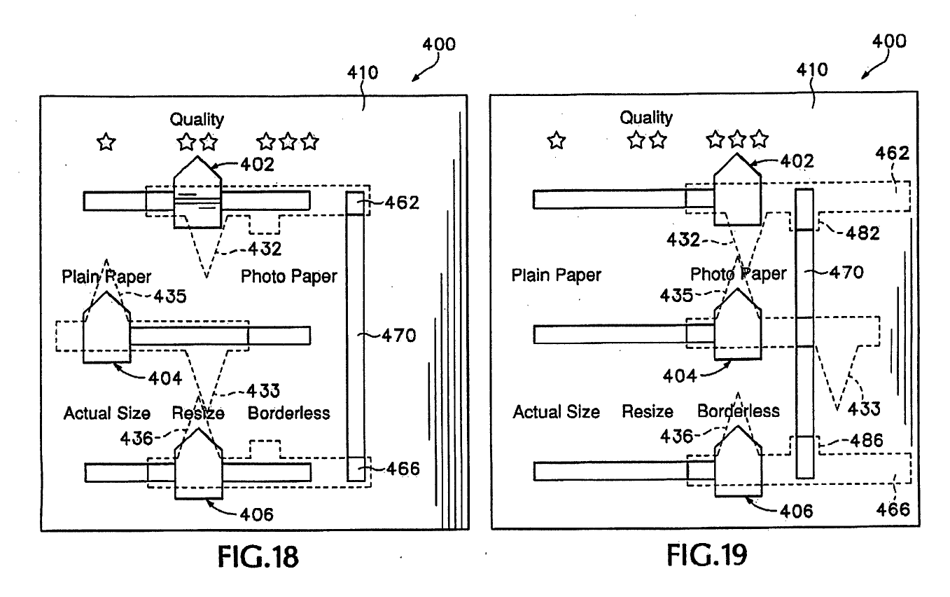

FIG. 18 illustrates the sliders 402, 404, and 406 in another example engaged configuration. In this configuration, the arms 432, 435 are unengaged. The arms 433, 436 are engaged. As such, in this configuration, when the slider 404 selects “plain paper” engagement of the arms 433, 436 prevents the slider 406 from selecting “borderless”. Further, when the slider 404 selects “plain paper”, the slider 402 is free to select “one star”, “two star”, or “three star” options. By scanning along the scan line 470, the imaging device detects these settings by the presence of ends within the scan line.

FIG. 19 illustrates the sliders 402, 404, and 406 in another example engaged configuration. In this configuration, the arms 432, 435 are engaged. The arms 433, 436 are unengaged. As such, in this configuration, when the slider 402 selects “three star” quality, the slider 435 may select either “plain paper” or “photo paper” selections. Also, in this configuration, the slider 406 may select any of the size options provided.

The sliders 402, 406 may be used to select any of three options each. As such, each slider 402, 406 presents a different identifier along the scan line for each of the different options. The slider 402 includes a protrusion 482 that differs in width from the end 462 to permit the device to distinguish between the end 462 and the protrusion 482 positioned within the scan line 470. In the FIG. 19 configuration, the protrusion 482 is positioned in the scan line 470. Hence, as shown in FIG. 17, when “one star” quality is selected by the slider 402, no portion of the slider 402 is within the scan line 470. When “two star” quality is selected, as shown in FIG. 16, the end 462 is positioned in the scan line 470. When “three star” quality is selected as shown in FIG. 19, the protrusion 482 is within the scan line 470. In this manner, the device can determine a current selection of the slider 402 by the different scan results from scanning along the scan line 470.

Similarly, the slider 406 includes a protrusion 486 that differs in width from the end 482 to permit the device to distinguish between the end 444 and the protrusion 486 within the scan line 470.

It will be appreciated that many variations are possible in the examples given above, and many examples different than those described may be designed according to particular applications. Thus, while the present disclosure has been provided with reference to the foregoing embodiments, those skilled in the art will understand that many variations may be made therein without departing from the spirit and scope of the claims. The foregoing embodiments are illustrative, and no single feature, procedure or element is essential to all possible combinations that may be claimed in this or a later application. Moreover, the description should be understood to include all novel and non-obvious combinations of elements described herein, and claims may be presented in this or a later application to any novel and non-obvious combination of these elements. Where the claims recite “a” or “another” element or the equivalent thereof, such claims should be understood to include incorporation of one or more such elements, neither requiring nor excluding two or more such elements.

What is claimed:

1. An input device comprising:
a scanner;
an indication positioned relative to the scanner, the indication being adapted to be changed between optically distinctive states; and
a processor adapted to cooperate with the scanner to scan the indication and determine the state of the indication.

2. The input device of claim 1 in which the states of the indication relate to imaging operations to be performed relative to image data, and the processor is further adapted to produce instructions relating to the imaging operations based on the state of the scanned indication.

3. The input device of claim 1 further comprising at least one input element, the input element being adapted to be changed selectively between a plurality of states corresponding to the states of the indication, each input element being coupled to an indication, whereby a change in the state of an input element changes the state of the indication to which it is coupled.

4. The input device of claim 3 in which the indication is one of coupled mechanically to the input element, and coupled electrically to the input element.

5. The input device of claim 3 in which the states of the input element correspond to physical positions of the input element, and the input element is mechanically coupled to the indication.

6. The input device of claim 1 in which the indication includes an indication element, and the states of the indication correspond to physical configurations of the indication element, and the indication element is adapted to move at least one of between alternate positions, along a continuous path, at discrete positions, and in a two dimensional area.

7. The input device of claim 1, wherein the indication includes a push button and the states of the indication correspond to physical configurations of the push button.

8. The input device of claim 1, wherein the indication includes a rotary dial and the states of the indication correspond to physical configurations of the rotary dial.

9. The input device of claim 1, wherein the indication includes a slide and the states of the indication correspond to physical configurations of the slide.

10. The input device of claim 1, wherein the indication includes a display and the states of the indication correspond to different patterns on the display.

11. The input device of claim 1 in which the processor and scanner cooperate to scan successive states of the indication.

12. The input device of claim 1 further comprising a plurality of the indications, and the processor and scanner cooperate to scan successive states of the plurality of indications.

13. A device comprising:
a scanning window;
a scanner to scan a scanning zone of the scanning window;
a control panel adjacent to the scanning zone, the control panel including one or more indication elements, each indication element being movable relative to an indication region of the scanning zone, the scanner being adapted to scan the indication region and produce indication image information based on the position of the indication element relative to the associated indication region.

14. The device of claim 13 in which the relative position of the indication element relative to the indication zone represents imaging control information, the image input device further comprising a processor coupled to the scanner and adapted to determine imaging control information from the indication image information.

15. A method of imaging an object comprising:
selecting a state of an indication from optically distinctive selectable states;
scanning the indication;
performing imaging operations image data using the scanned indication.

16. The method of claim 15 in which selecting a state of an indication includes operatively coupling an input element to the indication, and selecting a state of the input element from a plurality of selectable states.

17. The method of claim 15 in which selecting a state of an indication includes mechanically coupling an input element to an indication element, and moving the input element between a plurality of selectable positions moves the indication element between a corresponding plurality of positions corresponding to the plurality of states.

18. The method of claim 15 in which providing an indication includes moving an indication element at least one of between alternate positions, along a continuous path, to discrete positions, and in a two dimensional area, the method further comprising determining the position of the indication element from the scanned indication.

19. An imaging device comprising:
a scanner to scan a scan zone;
means for indicating in the scan zone at least one of a plurality of visually distinctive selectable states; and
means for performing an imaging process in cooperation with the scanner, and performing imaging operations relating to image data based on the scanned indication.

20. The device of claim 19 in which the means for indicating includes manipulating an indication between positions representative of the states.

21. A device, comprising:
a control panel having elements movable to selectively engage each other;
a scanner configured to detect a position of the elements.

22. The device of claim 21, further comprising a controller to control device operation using the position of the elements as detected by the scanner.

23. The device of claim 21, wherein the control panel comprises a surface, a portion of each element being disposed on each side of the surface.

24. The device of claim 23, wherein written indicia indicating different selections is disposed on the surface.

25. The device of claim 23, wherein at least one of the elements has a varying width, and wherein the scanner detects the width of the element that is positioned within a scan line.
